(19) United States
(12) Patent Application Publication
(10) Pub. No.: US 2008/0168622 A1
(43) Pub. Date: Jul. 17, 2008

(54) Hinge assembly

(75) Inventor: Chun-Ching Hsu, Shulin City (TW)

Correspondence Address: Joe McKinney Muncy, PO Box 1364, Fairfax, VA, 22038-1364, US

(73) Assignee: SHIN ZU SHING CO., LTD.

(21) Appl. No.: 11/652,503

(22) Filed: Jan. 12, 2007

(51) Int. Cl. E05D 5/02; E05D 11/10

(52) U.S. Cl. 16/319; 16/382

(57) ABSTRACT

A hinge assembly has multiple components that have mounting holes and mounting protrusions respectively. The mounting protrusions are formed on the components and correspond to and are mounted rotatably in the mounting holes respectively. Such that the hinge assembly is assembled without any additional connecting elements like bolts and fabrication of the hinge assembly may be convenient and low-cost.

### BACKGROUND OF THE INVENTION

1. Field of the Invention

The present invention relates to a hinge, and more particularly to a hinge assembly that is convenient and low-cost to fabricate.

2. Description of Related Art

An electronic display such as a LCD or a computer monitor generally comprises a base, a panel and a hinge assembly. The hinge assembly is typically mounted between the panel and the base to make the panel rotatable relative to the base for convenience of watching the panel.

Mostly, the conventional hinge assembly comprises multiple components that have multiple mounting holes and multiple bolts. The mounting holes are formed through the components and correspond to each other respectively. The bolts extend though and mounted pivotally in the corresponding mounting holes. With such an arrangement, the conventional hinge assembly is rotatable to adjust the visual angle or orientation of the panel and facilitate watching.

However, since the bolts are additionally provided and are necessarily mounted along with the components, fabrication of the conventional hinge assembly is time-consuming and high-cost.

To overcome the shortcomings, the present invention provides a hinge assembly to obviate or mitigate the aforementioned problems.

### SUMMARY OF THE INVENTION

The main objective of the present invention is to provide a hinge assembly that is convenient to fabricate and rotatable to adjust the angle or orientation.

The secondary objective of the present invention is to provide a hinge assembly that is low-cost to fabricate.

To achieve the objectives, the hinge assembly in accordance with the present invention comprises multiple components that have mounting holes and mounting protrusions respectively. The mounting protrusions are formed on the components and correspond to and are mounted rotatably in the mounting holes respectively. Such that the hinge assembly is assembled without any additional connecting elements like bolts and fabrication of the hinge assembly may be convenient and low-cost.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge assembly in accordance with the present invention;

FIG. 2 is an exploded perspective view of the hinge assembly in FIG. 1;

FIG. 3 is a side view of the hinge assembly in FIG. 1;

FIG. 4 is a cross sectional end view of the hinge assembly along line 4-4 in FIG. 3;

FIG. 5 is a top view of the hinge assembly in FIG. 1; and

FIG. 6 is a cross sectional end view of another embodiment of the hinge assembly in accordance with the present invention.

### DETAILED DESCRIPTION OF THE PREFERRED EMBODIMENT

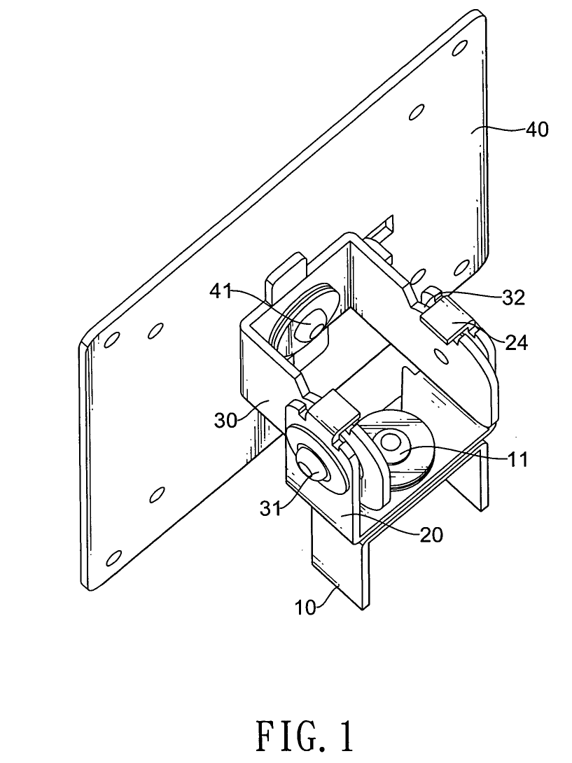

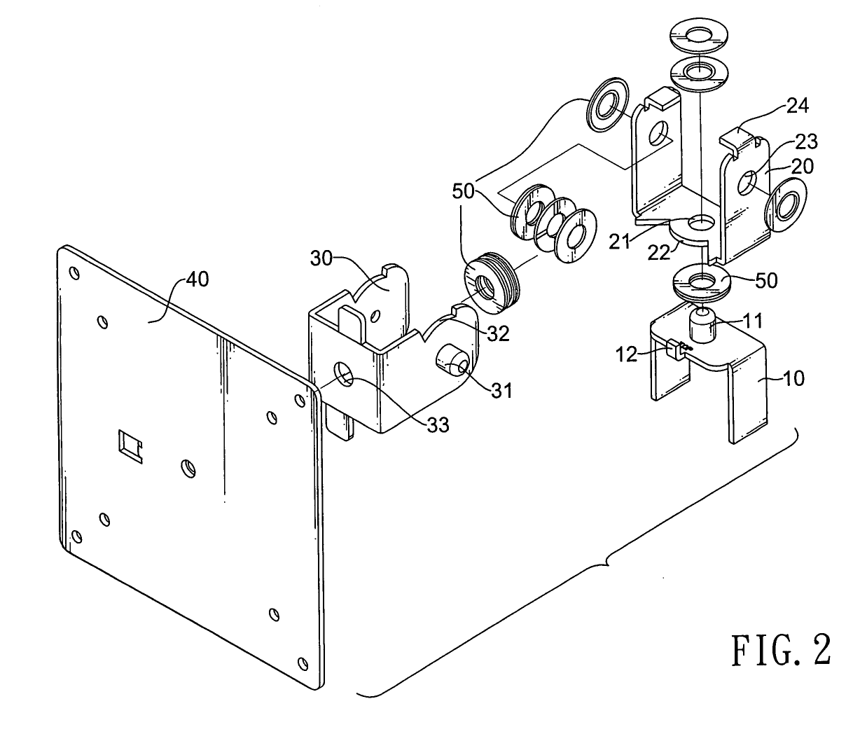

With reference to FIGS. 1 and 2, the hinge assembly in accordance with the present invention comprises a stage (10), a rotating bracket (20), a mounting bracket (30), a fixing board (40) and multiple spacing and retaining assemblies (50).

The stage (10) can be installed in a base of an electronic display and has a top, an edge, a first mounting protrusion (11) and a first limit (12). The first mounting protrusion (11) is formed on the top of the stage (10) by means of punching, pressing . . . etc. The first limit (12) is formed on the edge of the stage (10).

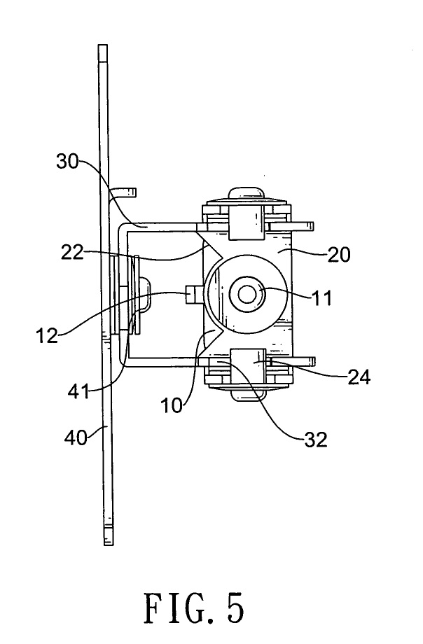

With further reference to FIG. 5, the rotating bracket (20) is U-shaped, is mounted rotatably on the top of the stage (10) and has a central wing and two side wings. The central wing has two ends, an inner edge, a first mounting hole (21) and a first notch (22). The first mounting hole (21) is formed through the central wing of the rotating bracket (20) and corresponds to and is mounted rotatably around the first mounting protrusion (11) of the stage (10). The first notch (22) is formed in the inner edge of the central wing, receives the first limit (12) of the stage (10) inside and has a length and two ends. The ends of the first notch (22) selectively abut the first limit (12) to limit the rotating angle of the rotating bracket (20) relative to the stage (10). The side wings are formed perpendicularly and respectively on the two ends of the central wing. Each side wing has a distal end, a second mounting hole (23) and a second limit (24). The second mounting hole (23) is formed through the side wing near the distal end of the side wing. The second limit (24) extends out of the distal end of the side wing of the rotating bracket (20). The second limits (24) of the side wings correspond to and extend toward each other.

The mounting bracket (30) is U-shaped, is mounted rotatably on the rotating bracket (20) and has a main leaf and two side leaves. The main leaf has two ends, a middle, and a fixing hole (33). The fixing hole (33) is formed through the middle of the main leaf. The side leaves are formed perpendicularly and respectively on two ends of the main leaf. Each side leaf has an outer surface, a top edge, a second mounting protrusion (31) and a second notch (32). The second mounting protrusion (31) is formed on the outer surface of the side leaf and corresponds to and is mounted rotatably in the second mounting holes (23) of the rotating bracket (20). The second notch (32) is formed in the top edge of the side leaf of the mounting bracket (30), receives the corresponding second limit (24) of the rotating bracket (20) and has a length and two ends. The ends of the second notch (32) selectively abut the corresponding second limit (24) to limit the rotating angle of the mounting bracket (30) relative to the rotating bracket (20).

The fixing board (40) can be mounted securely to a panel of the electronic display and has a middle and a third mounting protrusion (41). The third mounting protrusion (41) is formed on the middle of the fixing board (40) by means of punching, pressing . . . etc. and corresponds to and extends through the fixing hole (33) of the mounting bracket (30) to connect the fixing board (40) to the mounting bracket (30).

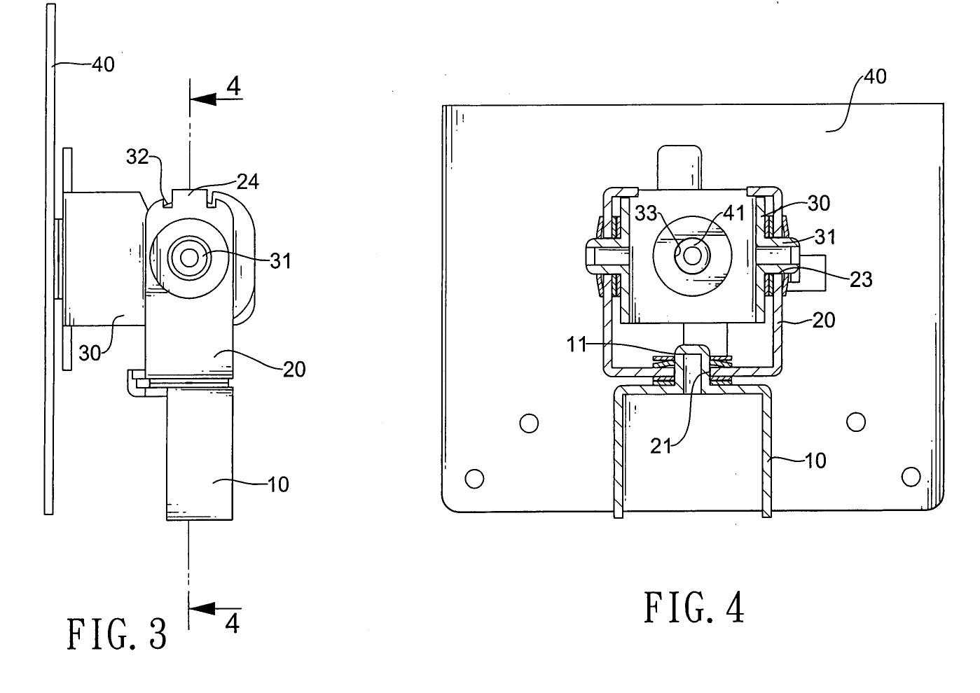

With further reference to FIGS. 3 and 4, the spacing and retaining assemblies (50) are mounted respectively around the first mounting protrusion (11) of the stage (10) and the second mounting protrusions (31) of the mounting bracket (30) to space the stage (10), the rotating bracket (20) and the mounting bracket (30) and prevent abrasion. Furthermore, the spacing and retaining assemblies (50) provide additional support to support retaining the stage (10), the rotating bracket (20) and the mounting bracket (30).

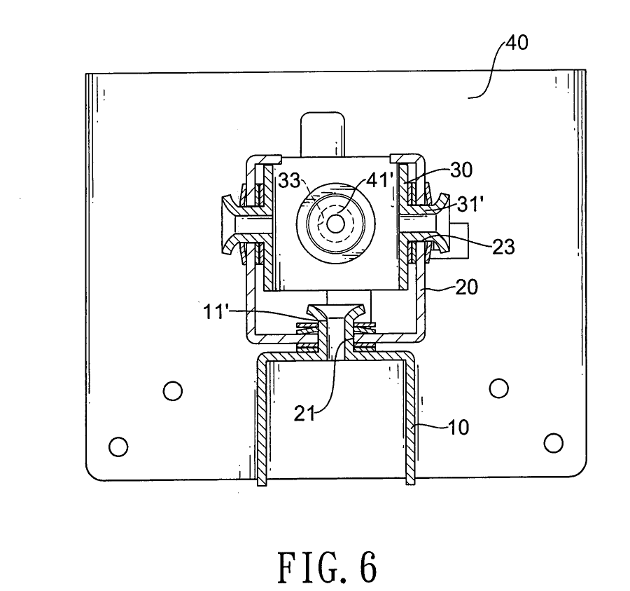

With further reference to FIG. 6, in the second embodiment, the first mounting protrusion (11′) of the stage (10), the second mounting protrusions (31′) of the mounting bracket (30) and the third mounting protrusion (41′) of the fixing board (40) may respectively further have opening ends. Such that when the mounting protrusions (11′, 31′, 41′) are mounted respectively around the corresponding mounting holes (21, 23, 33), the open ends of the mounting protrusions (11′, 31′, 41′) can be pressed and deformed to hold the rotating bracket (20) and the mounting bracket (30) securely.

With such an arrangement, the hinge assembly in accordance with the present invention is mounted between the panel and the base of the electronic display and allows the panel to rotate relative to the base for convenience of watching. Since the hinge assembly is assembled directly by engagement of the mounting protrusions (11)(11′)(31)(41) and mounting holes (21)(23)(33), fabrication of the hinge assembly may be convenient and low-cost.

Even though numerous characteristics and advantages of the present invention have been set forth in the foregoing description together with details of the structure and function of the invention, the disclosure is illustrative only. Changes may be made in detail especially in matters of shape, size and arrangement of parts within the principles of the invention to the full extent indicated by the broad general meaning of the terms in which the appended claims are expressed.

What is claimed is:

1. A hinge assembly comprising
a stage having at least one mounting protrusion;
a mounting bracket having at least one mounting protrusion; and
a rotating bracket having at least two mounting holes being respectively corresponding to and mounted rotatably around the mounting protrusions of the stage and the mounting bracket.

2. The hinge assembly as claimed in claim 1, wherein the stage has
a top;
an edge; and
a first mounting protrusion being formed on the top of the stage; the rotating bracket is U-shaped and has
a central wing having
two ends;
an inner edge; and
a first mounting hole being formed through the central wing of the rotating bracket and corresponding to and being mounted rotatably around the first mounting protrusion of the stage; and
two side wings being formed perpendicularly and respectively on the two ends of the central wing, each side wing having
a distal end; and
a second mounting hole being formed through the side wing near the distal end of the side wing; and
the mounting bracket is U-shaped and has
a main leaf having
two ends; and
a middle; and
two side leaves being formed perpendicularly and respectively on two ends of the main leaf, each side leaf having
an outer surface;
a top edge; and
a second mounting protrusion being formed on the outer surface of the side leaf and corresponding to and mounted rotatably in a corresponding one of the second mounting holes of the rotating bracket.

3. The hinge assembly as claimed in claim 2, wherein
the stage further has a first limit being formed on the edge of the stage; and
the rotating bracket further has
a first notch being formed in the inner edge of the central wing, receiving the first limit of the stage inside and having
a length; and
two ends selectively abut the first limit to limit a rotating angle of the rotating bracket relative to the stage.

4. The hinge assembly as claimed in claim 2, wherein
the rotating bracket further has two second limits extending out of the distal ends of the side wings of the rotating bracket corresponding to and extend toward each other; and
the mounting bracket further has a second notch being formed in the top edge of each side leaf of the mounting bracket, receiving one of the second limits of the rotating bracket and having
a length; and
two ends selectively abut the corresponding second limit to limit a rotating angle of the mounting bracket relative to the rotating bracket.

5. The hinge assembly as claimed in claim 2, wherein the mounting bracket further has a fixing hole being formed through a middle of the mounting bracket; and
the hinge assembly further has a fixing board having
a middle; and
a third mounting protrusion being formed on the middle of the fixing board and corresponding to and extending through the fixing hole of the mounting bracket to connect the fixing board to the mounting bracket.

6. The hinge assembly as claimed in claim 2, wherein the first mounting protrusion and the second mounting protrusions further has opening ends respectively.
